(19) United States
(12) Patent Application Publication
(10) Pub. No.: US 2007/0095165 A1
(43) Pub. Date: May 3, 2007

(54) Pedal assembly for bicycle

(76) Inventor: Jin-Long Xie, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/264,798

(22) Filed: Nov. 1, 2005

(51) Int. Cl. G05G 1/14

(52) U.S. Cl. 74/594.4

(57) ABSTRACT

A pedal assembly for a bicycle includes a pedal body, a pivot seat, and a bearing. The pedal body has a side provided with a pivot seat for mounting a single bearing, so that the position of the axial center of the pivot seat can be changed to reduce the distance between the force applying point of the user's foot and the axial center of the pedal body greatly. Thus, the force applying point of the user's foot is closer to the axial center of the pedal body, so that the rotation radius of the pedal body is closer to that of the crank of the bicycle, thereby saving the manual work and decreasing the centrifugal effect.

### BACKGROUND OF THE INVENTION

1. Field of the Invention

The present invention relates to a pedal assembly, and more particularly to a pedal assembly for a bicycle.

2. Description of the Related Art

A conventional pedal for a bicycle comprises a pedal body, a shaft tube mounted on a central portion of the pedal body, two bearings mounted in the shaft tube, and a positioning element mounted in the pedal body. However, the conventional pedal consists of multiple parts, so that the conventional pedal has a complicated construction, thereby increasing the whole weight of the pedal, and thereby increasing the costs of fabrication. In addition, the central portion of the pedal body is integrally formed with the shaft tube, so that the configuration of the pedal body is fixed and cannot be changed arbitrarily, thereby decreasing the aesthetic quality of the pedal assembly.

A conventional pedal in accordance with the prior art is mounted on a shoe as shown in FIG. 30. As shown in FIG. 30, the distance between the force applying point of the user's foot (or shoe sole) and the axial center of the pedal body 100 is indicated by “H2”. However, the force applying point of the user's foot is distant from the axial center of the pedal body 100, so that the distance “H2” has a greater value. Thus, the rotation radius of the pedal body 100 is distant from that of the crank of the bicycle, thereby wasting the manual work, and thereby increasing the centrifugal effect.

### SUMMARY OF THE INVENTION

In accordance with the present invention, there is provided a pedal assembly, comprising a pedal body, a pivot seat extending outward from a side of the pedal body and pivotally connected to a crank of a bicycle, and a bearing mounted in the pivot seat.

The primary objective of the present invention is to provide a pedal assembly, wherein the pedal body has a side provided with a pivot seat for mounting a single bearing, so that the position of the axial center of the pivot seat can be changed to reduce the distance between the force applying point of the user's foot and the axial center of the pedal body greatly.

Another objective of the present invention is to provide a pedal assembly, wherein the force applying point of the user's foot is closer to the axial center of the pedal body, so that the rotation radius of the pedal body is closer to that of the crank of the bicycle, thereby saving the manual work, and thereby decreasing the centrifugal effect.

A further objective of the present invention is to provide a pedal assembly, wherein the pedal body has a side provided with a single bearing, so that the pedal body has a hollow central portion which needs not to provide a shaft tube, thereby decreasing the whole weight of the pedal assembly, and thereby decreasing the costs of fabrication.

A further objective of the present invention is to provide a pedal assembly, wherein the central portion of the pedal body needs not to provide a shaft tube, so that the configuration of the pedal body can be changed arbitrarily, thereby enhancing the aesthetic quality of the pedal assembly.

A further objective of the present invention is to provide a pedal assembly, wherein the pedal assembly is both available for a road use bicycle and a mountaineering bicycle, thereby greatly enhancing the versatility of the pedal assembly.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a pedal assembly in accordance with the preferred embodiment of the present invention.

FIG. 2 is an exploded perspective view of the pedal assembly as shown in FIG. 1.

FIG. 3 is a partially plan cross-sectional view of the pedal assembly taken along line 3-3 as shown in FIG. 1.

FIG. 4 is a partially plan cross-sectional view of a pedal assembly in accordance with another preferred embodiment of the present invention.

FIG. 5 is a perspective view of a pedal assembly in accordance with another preferred embodiment of the present invention.

FIG. 6 is an exploded perspective view of the pedal assembly as shown in FIG. 5.

FIG. 7 is a plan cross-sectional view of the pedal assembly taken along line 7-7 as shown in FIG. 5.

FIG. 8 is a perspective view of a pedal assembly in accordance with another preferred embodiment of the present invention.

FIG. 9 is an exploded perspective view of the pedal assembly as shown in FIG. 8.

FIG. 10 is a plan cross-sectional view of the pedal assembly taken along line 10-10 as shown in FIG. 8.

FIG. 11 is a perspective view of a pedal assembly in accordance with another preferred embodiment of the present invention.

FIG. 12 is an exploded perspective view of the pedal assembly as shown in FIG. 11.

FIG. 13 is a plan cross-sectional view of the pedal assembly taken along line 13-13 as shown in FIG. 11.

FIG. 14 is a perspective view of a pedal assembly in accordance with another preferred embodiment of the present invention.

FIG. 15 is an exploded perspective view of the pedal assembly as shown in FIG. 14.

FIG. 16 is a plan cross-sectional view of the pedal assembly taken along line 16-16 as shown in FIG. 14.

FIG. 17 is a perspective view of a pedal assembly in accordance with another preferred embodiment of the present invention.

FIG. 18 is an exploded perspective view of the pedal assembly as shown in FIG. 17.

FIG. 19 is a plan cross-sectional view of the pedal assembly taken along line 19-19 as shown in FIG. 17.

FIG. 20 is a perspective view of a pedal assembly in accordance with another preferred embodiment of the present invention.

FIG. 21 is an exploded perspective view of the pedal assembly as shown in FIG. 20.

FIG. 22 is a plan cross-sectional view of the pedal assembly taken along line 22-22 as shown in FIG. 20.

FIG. 23 is a partially plan cross-sectional view of a pedal assembly in accordance with another preferred embodiment of the present invention.

FIG. 24 is a partially plan cross-sectional view of a pedal assembly in accordance with another preferred embodiment of the present invention.

FIG. 25 is a perspective view of a pedal assembly in accordance with another preferred embodiment of the present invention.

FIG. 26 is an exploded perspective view of the pedal assembly as shown in FIG. 25.

FIG. 27 is a plan cross-sectional view of the pedal assembly taken along line 27-27 as shown in FIG. 25.

FIG. 28 is a perspective view of a pedal assembly in accordance with another preferred embodiment of the present invention.

FIG. 29 is a schematic plan view of a pedal assembly mounted on a shoe in accordance with the preferred embodiment of the present invention.

FIG. 30 is a schematic plan view of a conventional pedal mounted on a shoe in accordance with the prior art.

### DETAILED DESCRIPTION OF THE INVENTION

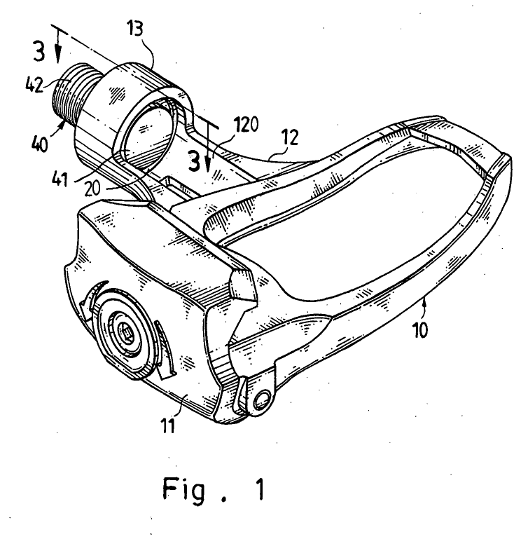

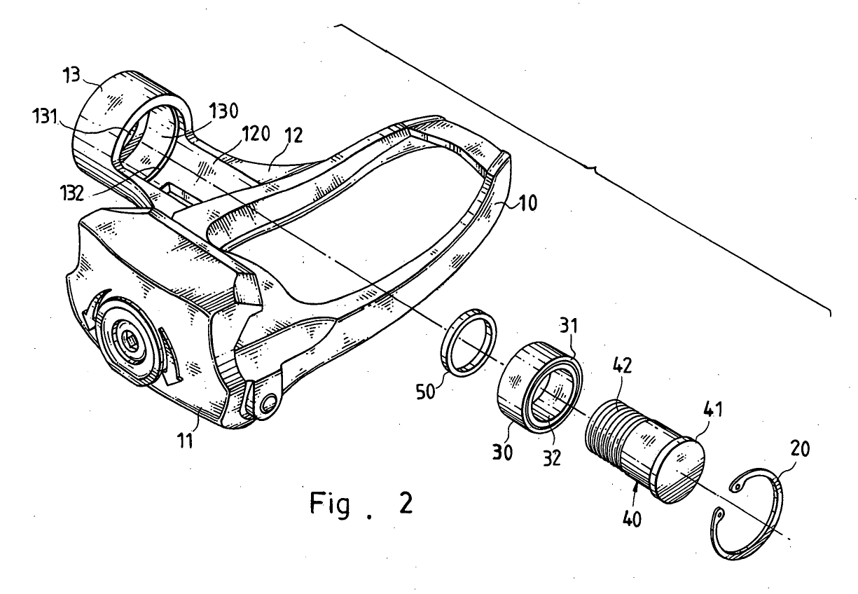

Referring to the drawings and initially to FIGS. 1-3, a pedal assembly for a bicycle in accordance with the preferred embodiment of the present invention comprises a pedal body 10, a pivot-seat 13 extending outward from a side of the pedal body 10 and pivotally connected to a crank (not shown) of a bicycle, a bearing 30 mounted in the pivot seat 13, and a hook plate 11 pivotally mounted on the pedal body 10. The pedal body 10 is a road use pedal body. The pivot seat 13 has an inside formed with a receiving recess 130 for mounting the bearing 30. The receiving recess 130 of the pivot seat 13 has an opening directed toward the pedal body 10.

The pedal assembly further comprises an extension 12 extending outward from the side of the pedal body 10 and located between the pedal body 10 and the pivot seat 13, and a pivot shaft 40 extended through the bearing 30 and protruded outward from the pivot seat 13.

The extension 12 has an inside formed with a channel 120 communicating with the receiving recess 130. The pivot shaft 40 is closely fit in the bearing 30. The pivot shaft 40 has a first end protruded outward from the pivot seat 13 and formed with an outer thread 42 for connecting the crank of the bicycle and a second end formed with an outwardly extending catch ring 41 rested on a side of the bearing 30.

The pedal assembly further comprises a bushing 50 mounted between the bearing 30, the pivot shaft 40 and the pivot seat 13. The receiving recess 130 of the pivot seat 13 has an end face formed with a through hole 131 to allow passage of the bushing 50. The bushing 50 is rested on an inner ring 32 of the bearing 30.

The pedal assembly further comprises a substantially C-shaped retaining member 20 secured in the pivot seat 13 and rested on an outer ring 31 of the bearing 30 so that the bearing 30 is clamped in the pivot seat 13 by the retaining member 20. The receiving recess 130 of the pivot seat 13 has a periphery formed with an annular retaining groove 132 to retain the retaining member 20.

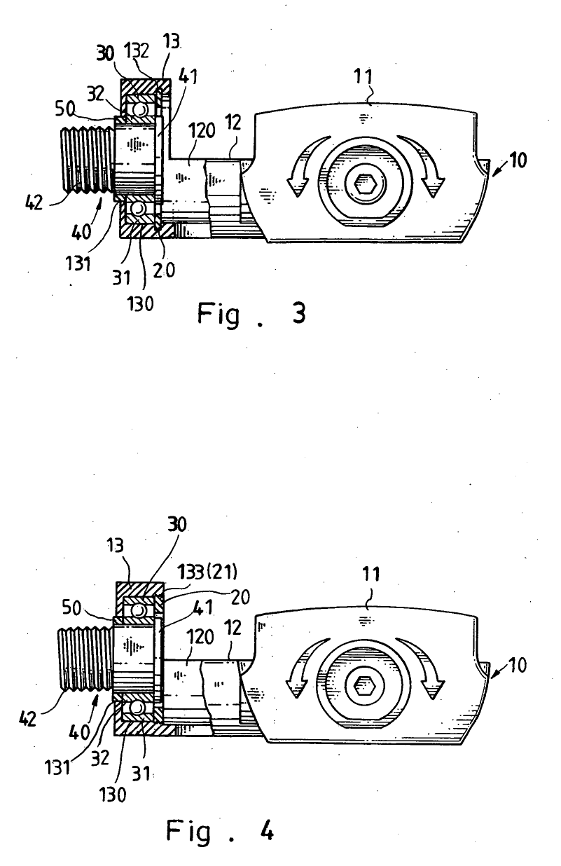

Referring to FIG. 4, the retaining groove 132 is undefined, the receiving recess 130 of the pivot seat 13 has a periphery formed with an inner thread 133, and the retaining member 20 has an outer thread 21 screwed into the inner thread 133 of the pivot seat 13, so that the retaining member 20 is secured in the pivot seat 13.

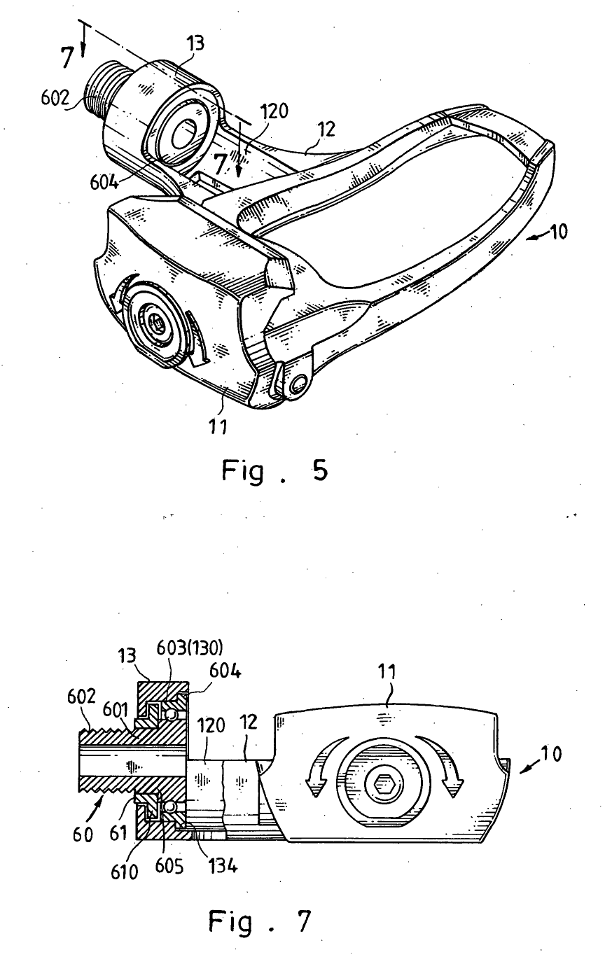

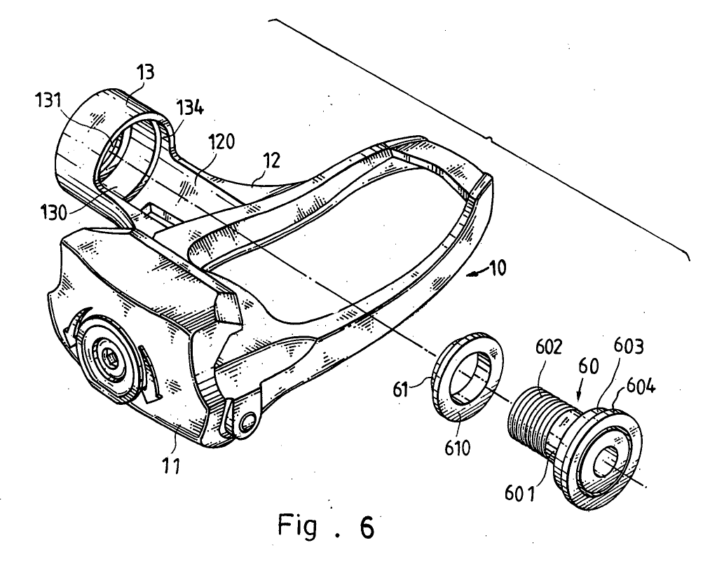

Referring to FIGS. 5-7, the receiving recess 130 of the pivot seat 13 has a periphery formed with a stepped groove 134, the bearing 60 has an outer ring 603 formed with an enlarged resting edge 604 rested in the stepped groove 134 of the pivot seat 13, the pivot shaft 601 has a first end protruded outward from the pivot seat 13 and formed with an outer thread 602 for connecting the crank of the bicycle and a second end integrally formed on the bearing 60, and the bushing 61 has a stepped shape and has an annular flange 610 rested on an inner ring 605 of the bearing 60 and an end face of the receiving recess 130 of the pivot seat 13.

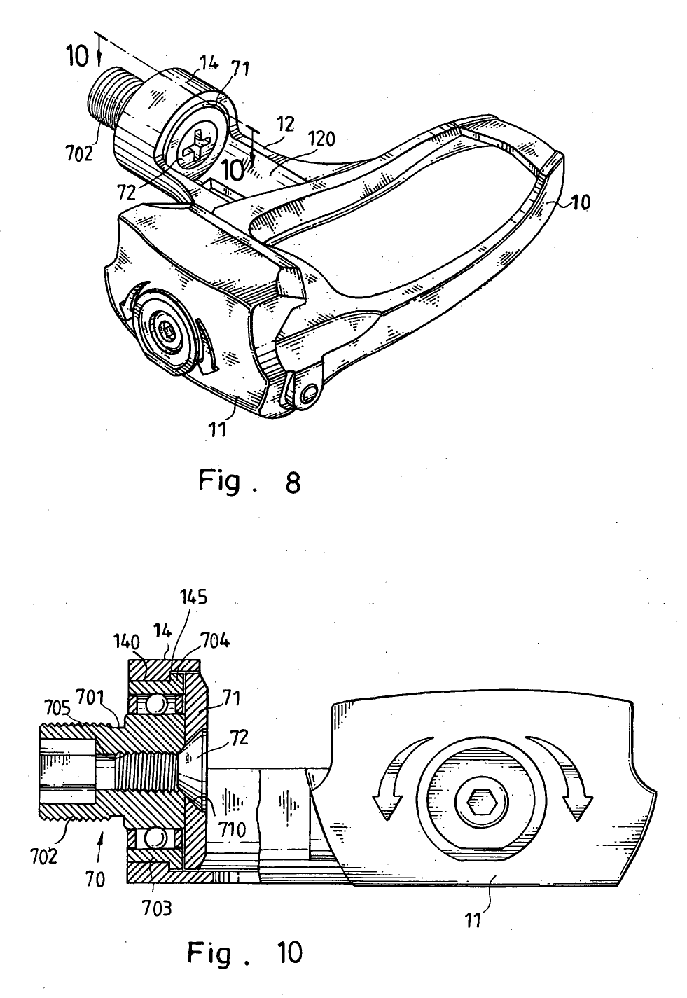

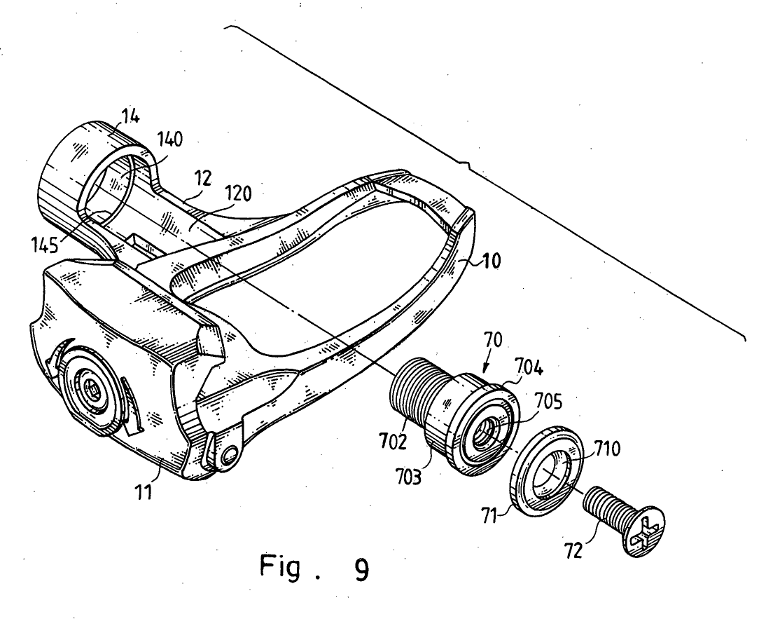

Referring to FIGS. 8-10, the receiving recess 140 of the pivot seat 14 has a periphery formed with a stepped groove 145, the bearing 70 has an outer ring 703 formed with an enlarged resting edge 704 rested in the stepped groove 145 of the pivot seat 14 and has an inside formed with a screw bore 705, the pivot shaft 701 has a first end protruded outward from the pivot seat 14 and formed with an outer thread 702 for connecting the crank of the bicycle and a second end integrally formed on the bearing 70, the bushing 71 is rested on the resting edge 704 of the outer ring 703 of the bearing 70 and an inside formed with a tapered through hole 710, and the pedal assembly further comprises a screw member 72 extended through the through hole 710 of the bushing 71 and screwed into the screw bore 705 of the bearing 70 to lock the bearing 70 and the bushing 71 in the pivot seat 14.

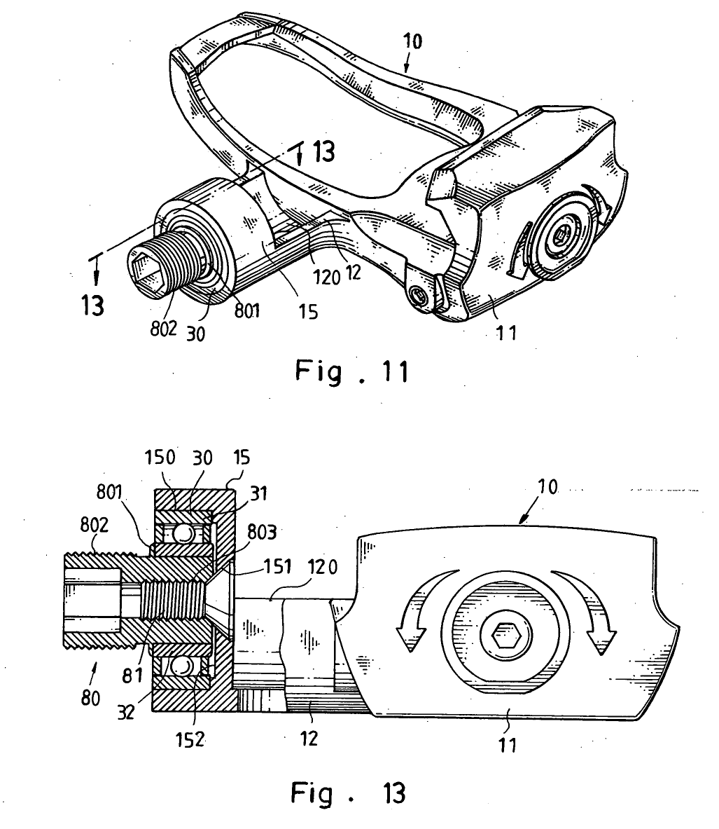

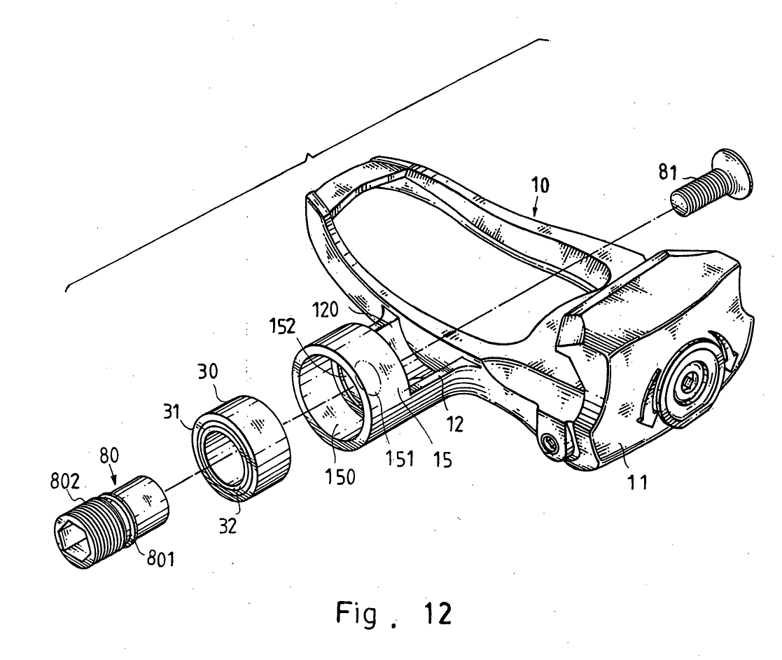

Referring to FIGS. 11-13, the receiving recess 150 of the pivot seat 15 has an opening directed outwardly relative to the pedal body 10 and has a stepped end face 152 rested on an outer ring 31 of the bearing 30 and formed with a tapered through hole 151, the pivot shaft 80 has a first end protruded outward from the pivot seat 15 and formed with an outer thread 802 for connecting the crank of the bicycle and a second end having an outer wall formed with an outwardly extending catch ring 801 rested on an inner ring 32 of the bearing 30 and an inner wall formed with a screw bore 803, and the pedal assembly further comprises a screw member 81 extended through the through hole 151 of the pivot seat 15 and screwed into the screw bore 803 of the pivot shaft 80 to lock the pivot shaft 80 and the bearing 30 in the pivot seat 15.

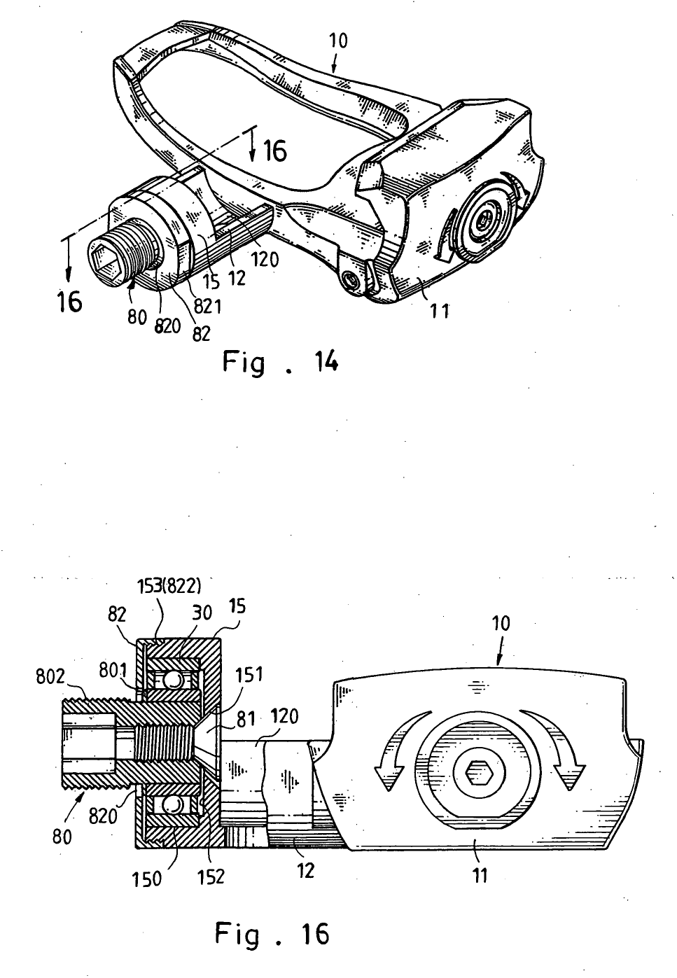

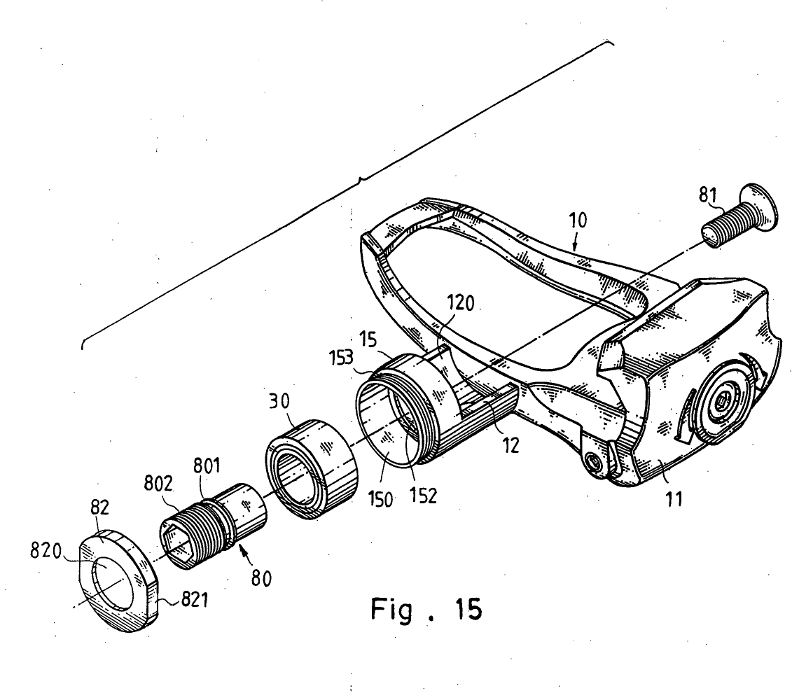

Referring to FIGS. 14-16, the pedal assembly further comprises a cover 82 mounted on the pivot seat 15 and the pivot shaft 80 and enclosed around the bearing 30 to seal the bearing 30. The pivot seat 15 has an outer thread 153, and the cover 82 has an inner thread 822 screwed onto the outer thread 153 of the pivot seat 15. The cover 82 has an inside formed with a shaft hole 820 to allow passage of the pivot shaft 80 and has a periphery formed with flattened edges 821.

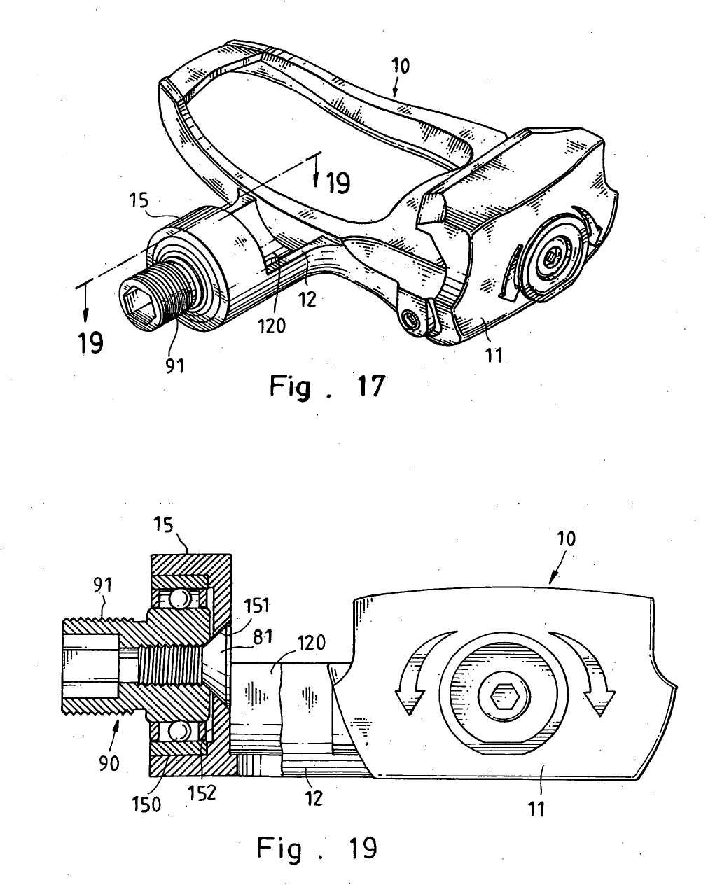

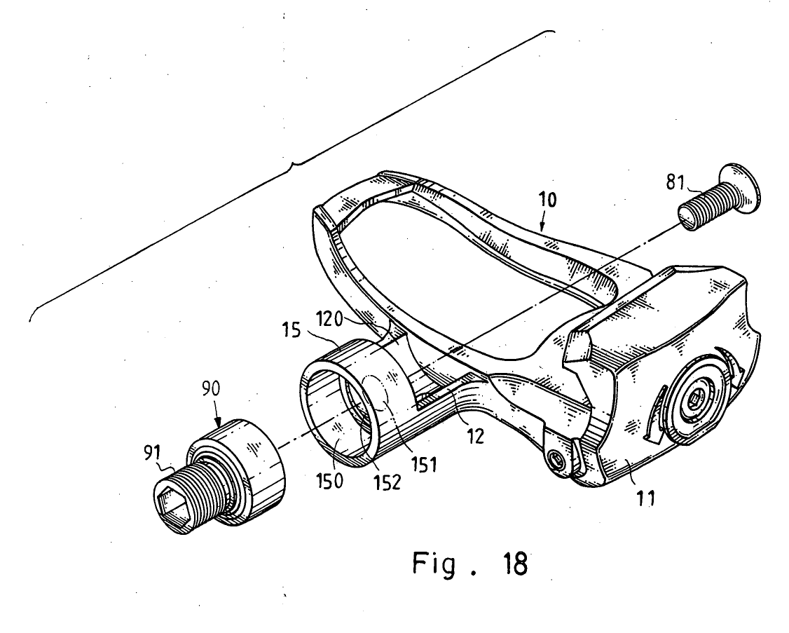

Referring to FIGS. 17-19, the pivot shaft 91 is integrally formed on the bearing 90.

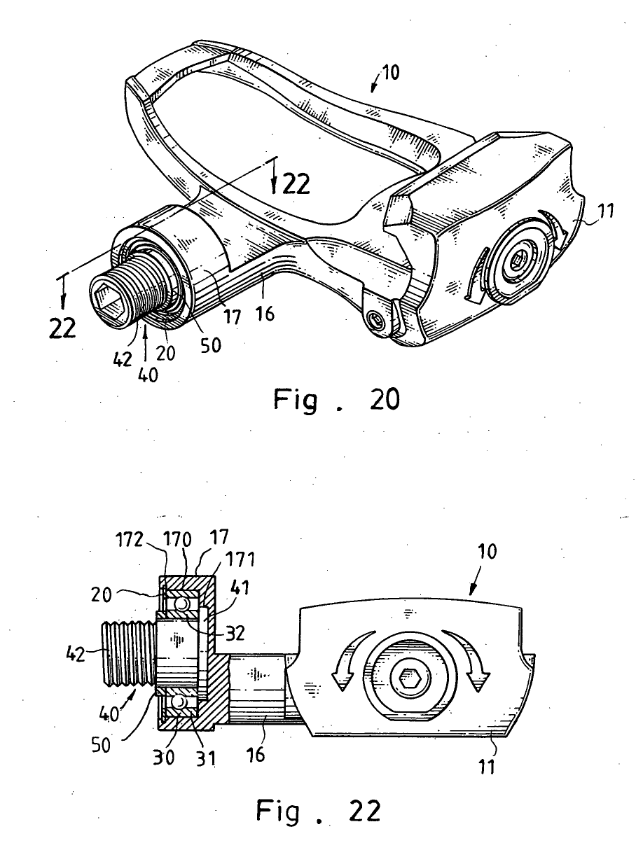

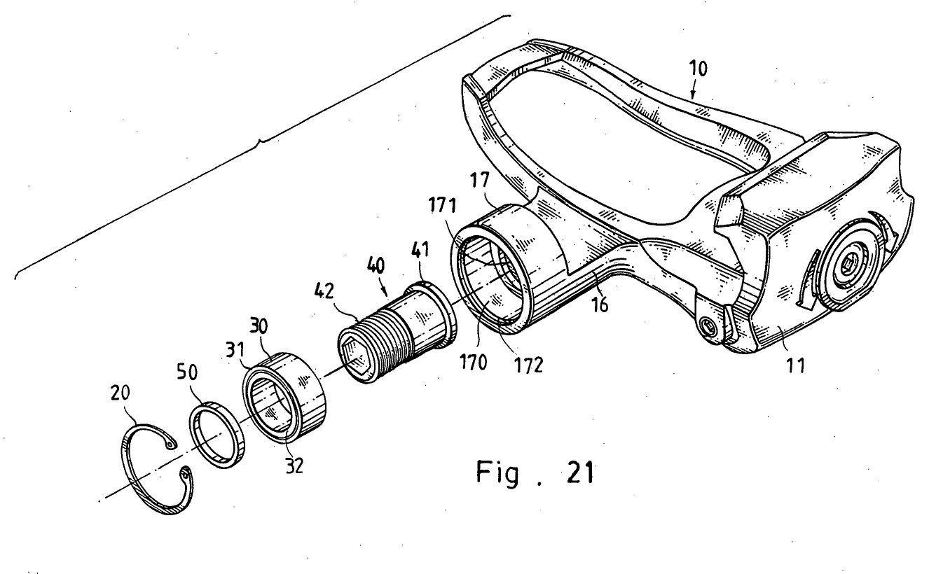

Referring to FIGS. 20-22, the receiving recess 170 of the pivot seat 17 has a closed end face connected to the extension 16 and formed with a stepped groove 171 to receive the catch ring 41 of the pivot shaft 40. The pedal assembly further comprises a bushing 50 mounted on the pivot shaft 40 and rested on an inner ring 32 of the bearing 30. The receiving recess 170 of the pivot seat 17 has a periphery formed with an annular retaining groove 172 to retain the retaining member 20.

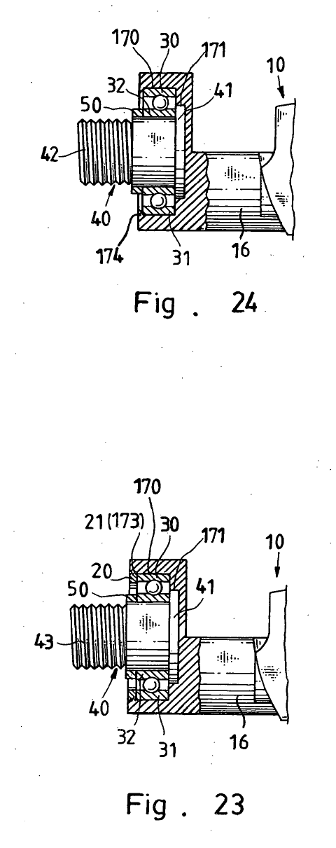

Referring to FIG. 23, the retaining groove 172 is undefined, the receiving recess 170 of the pivot seat 17 has a periphery formed with an inner thread 173, and the retaining member 20 has an outer thread 21 screwed into the inner thread 173 of the pivot seat 17, so that the retaining member 20 is secured in the pivot seat 17.

Referring to FIG. 24, the retaining groove 172 and the retaining member 20 are undefined, and the receiving recess 170 of the pivot seat 17 has a periphery formed with an inwardly extending catch flange 174 rested on an outer ring 31 of the bearing 30 so that the bearing 30 is clamped in the pivot seat 17 by the catch flange 174.

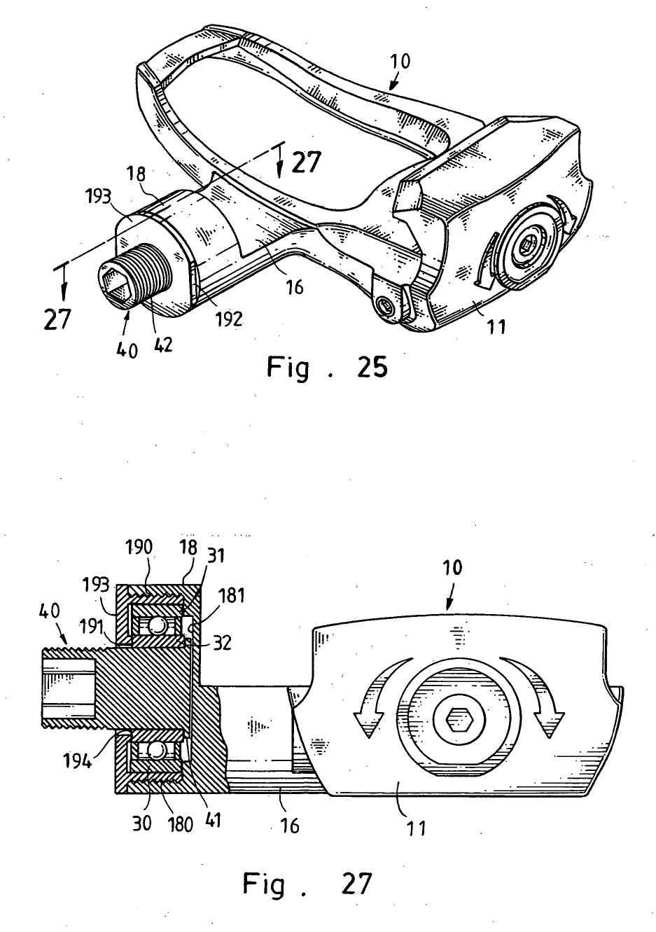

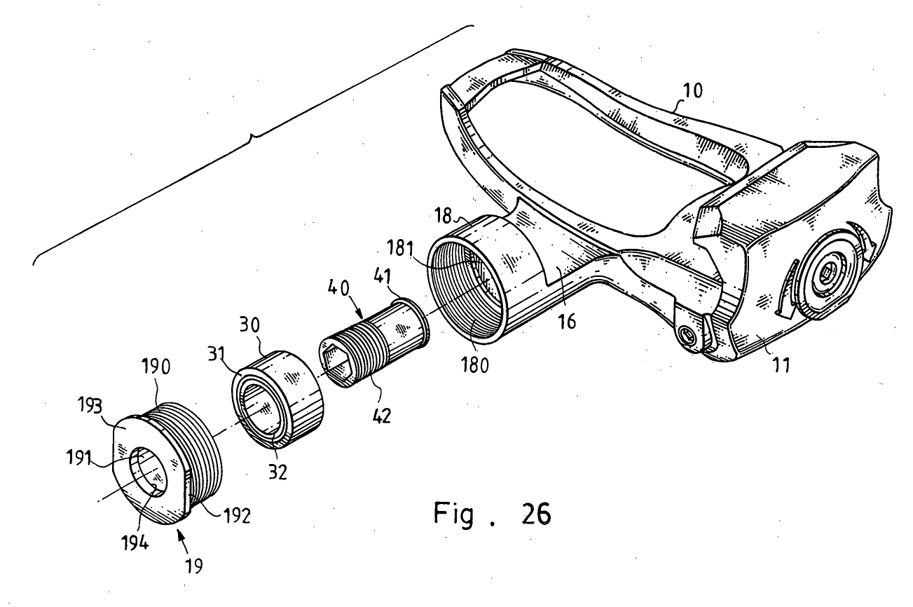

Referring to FIGS. 25-27, the pivot seat 18 has an inside formed with a threaded receiving recess 180 having an opening directed outwardly relative to the pedal body 10 and having a stepped end face 181 rested on an outer ring 31 of the bearing 30, and the pedal assembly further comprises an end cap 19 mounted on the pivot seat 18 and having a first portion mounted in the receiving recess 180 of the pivot seat 18 and closely fit on the bearing 30 and a second end formed with an enlarged cover 193 rested on the pivot seat 18 and the bearing 30 to lock the bearing 30 and the pivot shaft 40 in the pivot seat 18. The first portion of the end cap 19 has an outer thread 190 screwed into the receiving recess 180 of the pivot seat 18, and the cover 193 of the end cap 19 has an inside formed with a shaft hole 191 to allow passage of the pivot shaft 40 and has a periphery formed with flattened edges 192. The shaft hole 191 of the end cap 19 has a periphery formed with a protruding ring 194 rested on an inner ring 32 of the bearing 30.

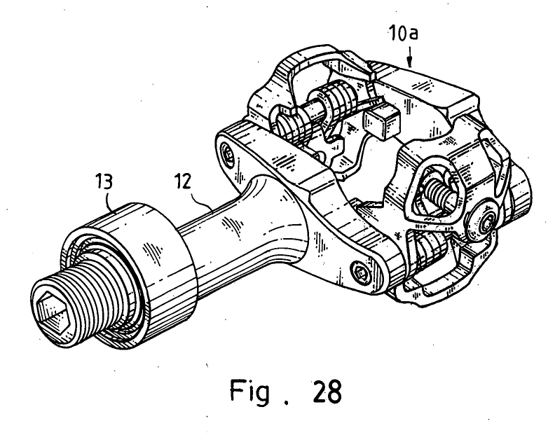

Referring to FIG. 28, the pedal body lOa is a mountaineering pedal body.

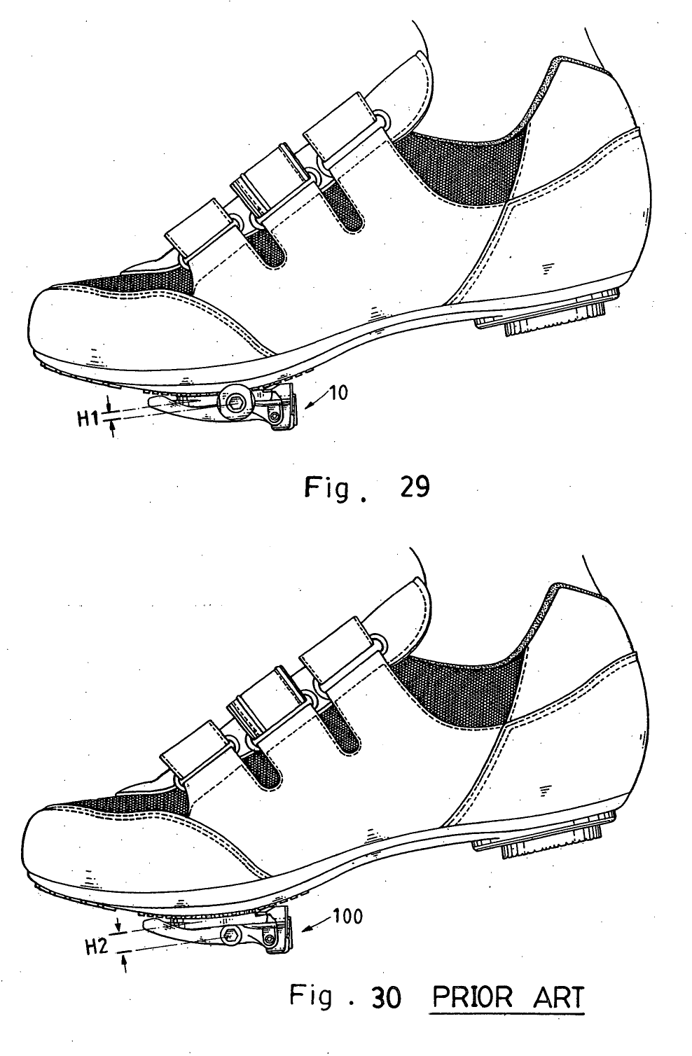

Referring to FIG. 29, the position of the axial center of the pivot seat 13 (15, 17 or 18) can be changed according to the requirement. In such a manner, the central point of the pivot seat 13 (15, 17 or 18) is the same as that of the extension 12 (or 16) or the pedal body 10 or a determined distance is defined between the central point of the pivot seat 13 (15, 17 or 18) and that of the extension 12 (or 16) or the pedal body 10, that is, the central point of the pivot seat 13 (15, 17 or 18) is located at a height greater than that of the extension 12 (or 16) or the pedal body 10. Thus, the distance “H1” between the force applying point of the user's foot (or shoe sole) and the axial center of the pedal body 10 is reduced greatly, so that the force applying point of the user's foot is closer to the axial center of the pedal body 10. It is appreciated that the distance “H1” as shown in FIG. 29 is smaller than the distance “H2” as shown in FIG. 30.

In conclusion, the pedal body has a side provided with a pivot seat for mounting a single bearing, wherein the position of the axial center of the pivot seat can be changed to reduce the distance between the force applying point of the user's foot and the axial center of the pedal body greatly, so that the force applying point of the user's foot is closer to the axial center of the pedal body. Thus, the rotation radius of the pedal body when being stepped is closer to that of the crank of the bicycle, so that the stepping circle of the user's foot produced when stepping on the pedal body has a smaller diameter, thereby saving the manual work, and thereby decreasing the centrifugal effect.

Accordingly, the pedal body has a side provided with a pivot seat for mounting a single bearing, so that the position of the axial center of the pivot seat can be changed to reduce the distance between the force applying point of the user's foot and the axial center of the pedal body greatly. In addition, the force applying point of the user's foot is closer to the axial center of the pedal body, so that the rotation radius of the pedal body is closer to that of the crank of the bicycle, thereby saving the manual work, and thereby decreasing the centrifugal effect. Further, the pedal body has a side provided with a single bearing, so that the pedal body has a hollow central portion which needs not to provide a shaft tube, thereby decreasing the whole weight of the pedal assembly, and thereby decreasing the costs of fabrication. Further, the central portion of the pedal body needs not to provide a shaft tube, so that the configuration of the pedal body can be changed arbitrarily, thereby enhancing the aesthetic quality of the pedal assembly. Further, the pedal assembly is both available for a road use bicycle and a mountaineering bicycle, thereby greatly enhancing the versatility of the pedal assembly.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A pedal assembly, comprising:
a pedal body;
a pivot seat extending outward from a side of the pedal body and pivotally connected to a crank of a bicycle;
a bearing mounted in the pivot seat.

2. The pedal assembly in accordance with claim 1, wherein the pivot seat has an inside formed with a receiving recess for mounting the bearing and having an opening directed toward the pedal body or directed outwardly relative to the pedal body.

3. The pedal assembly in accordance with claim 1, further comprising a pivot shaft extended through the bearing and protruded outward from the pivot seat.

4. The pedal assembly in accordance with claim 3, wherein the pivot shaft has a first end protruded outward from the pivot seat and formed with an outer thread for connecting the crank of the bicycle and a second end formed with an outwardly extending catch ring rested on a side of the bearing.

5. The pedal assembly in accordance with claim 3, further comprising a bushing mounted between the bearing, the pivot shaft and the pivot seat and rested on an inner ring of the bearing, wherein the pivot seat has an inside formed with a receiving recess having an end face formed with a through hole to allow passage of the bushing.

6. The pedal assembly in accordance with claim 3, wherein the pivot shaft is integrally formed on the bearing.

7. The pedal assembly in accordance with claim 1, further comprising a retaining member secured in the pivot seat and rested on an outer ring of the bearing so that the bearing is clamped in the pivot seat by the retaining member.

8. The pedal assembly in accordance with claim 3, wherein the pivot seat has an inside formed with a receiving recess having a periphery formed with a stepped groove, the bearing has an outer ring formed with an enlarged resting edge rested in the stepped groove of the pivot seat, the pivot shaft has a first end protruded outward from the pivot seat and formed with an outer thread for connecting the crank of the bicycle and a second end integrally formed on the bearing.

9. The pedal assembly in accordance with claim 8, further comprising a bushing mounted between the bearing, the pivot shaft and the pivot seat, wherein the bushing has a stepped shape and has an annular flange rested on an inner ring of the bearing and an end face of the receiving recess of the pivot seat.

10. The pedal assembly in accordance with claim 3, wherein the pivot seat has an inside formed with a receiving recess having a periphery formed with a stepped groove, the bearing has an outer ring formed with an enlarged resting edge rested in the stepped groove of the pivot seat and has an inside formed with a screw bore, the pivot shaft has a first end protruded outward from the pivot seat and formed with an outer thread for connecting the crank of the bicycle and a second end integrally formed on the bearing.

11. The pedal assembly in accordance with claim 10, further comprising a bushing mounted between the bearing, the pivot shaft and the pivot seat, wherein the bushing is rested on the resting edge of the outer ring of the bearing and an inside formed with a tapered through hole, and the pedal assembly further comprises a screw member extended through the through hole of the bushing and screwed into the screw bore of the bearing to lock the bearing and the bushing in the pivot seat.

12. The pedal assembly in accordance with claim 3, wherein the pivot seat has an inside formed with a receiving recess having a stepped end face rested on an outer ring of the bearing and formed with a tapered through hole, the pivot shaft has a first end protruded outward from the pivot seat and formed with an outer thread for connecting the crank of the bicycle and a second end having an outer wall formed with an outwardly extending catch ring rested on an inner ring of the bearing and an inner wall formed with a screw bore, and the pedal assembly further comprises a screw member extended through the through hole of the pivot seat and screwed into the screw bore of the pivot shaft to lock the pivot shaft and the bearing in the pivot seat.

13. The pedal assembly in accordance with claim 3, further comprising a cover mounted on the pivot seat and the pivot shaft and enclosed around the bearing to seal the bearing, wherein the pivot seat has an outer thread, the cover has an inner thread screwed onto the outer thread of the pivot seat, the cover has an inside formed with a shaft hole to allow passage of the pivot shaft and has a periphery formed with flattened edges.

14. The pedal assembly in accordance with claim 1, wherein the pivot seat has an inside formed with a threaded receiving recess having an opening directed outwardly relative to the pedal body and having a stepped end face rested on an outer ring of the bearing, and the pedal assembly further comprises an end cap mounted on the pivot seat and having a first portion mounted in the receiving recess of the pivot seat and closely fit on the bearing and a second end formed with an enlarged cover rested on the pivot seat and the bearing to lock the bearing and the pivot shaft in the pivot seat.

15. The pedal assembly in accordance with claim 14, wherein the first portion of the end cap has an outer thread screwed into the receiving recess of the pivot seat, the cover of the end cap has an inside formed with a shaft hole to allow passage of the pivot shaft and has a periphery formed with flattened edges, the shaft hole of the end cap has a periphery formed with a protruding ring rested on an inner ring of the bearing.

16. The pedal assembly in accordance with claim 1, further comprising an extension extending outward from the side of the pedal body and located between the pedal body and the pivot seat.

17. The pedal assembly in accordance with claim 4, wherein the pivot seat has an inside formed with a receiving recess having a closed end face connected to the extension and formed with a stepped groove to receive the catch ring of the pivot shaft, the pedal assembly further comprises a bushing mounted on the pivot shaft and rested on an inner ring of the bearing, the receiving recess of the pivot seat has a periphery formed with an annular retaining groove to retain the retaining member.

18. The pedal assembly in accordance with claim 7, wherein the pivot seat has an inside formed with a receiving recess having a periphery formed with an inner thread, and the retaining member has an outer thread screwed into the inner thread of the pivot seat, so that the retaining member is secured in the pivot seat.

19. The pedal assembly in accordance with claim 1, wherein the receiving recess of the pivot seat has a periphery formed with an inwardly extending catch flange rested on an outer ring of the bearing so that the bearing is clamped in the pivot seat by the catch flange.

20. The pedal assembly in accordance with claim 3, wherein the pivot seat has a central point located at a height greater than that of the pedal body.
